(19) United States
(12) Patent Application Publication
(10) Pub. No.: US 2025/0074463 A1
(43) Pub. Date: Mar. 6, 2025

(54) SURROUNDING AWARE TRAJECTORY PREDICTION

(71) Applicant: TuSimple, Inc., San Diego, CA (US)

(72) Inventors: Ethan ZHANG, San Diego, CA (US); Hao XIAO, San Diego, CA (US); Yiqian GAN, San Diego, CA (US); Yizhe ZHAO, San Diego, CA (US); Zhe HUANG, San Diego, CA (US); Lingting GE, San Diego, CA (US)

(21) Appl. No.: 18/434,630

(22) Filed: Feb. 6, 2024

Related U.S. Application Data
(60) Provisional application No. 63/579,614, filed on Aug. 30, 2023.

(51) Int. Cl. B60W 60/00; B60W 30/18; B60W 50/00; G06N 3/0442; G06N 3/0464

(52) U.S. Cl. CPC B60W 60/0011; B60W 30/18009; B60W 50/0097; B60W 60/0015; G06N 3/0442; G06N 3/0464; B60W 2556/10

(57) ABSTRACT

A method of predicting vehicle trajectory includes operating a scene encoder on an environmental representation surrounding a vehicle; concatenating an output of the scene encoder with a history trajectory; applying a sequence encoder to a result of the concatenating; refining an output of the sequence encoder based on the history trajectory; and generating one or more predicted future trajectories by operating a decoder on an output of the refining.

### CROSS-REFERENCE TO RELATED APPLICATIONS

This patent application claims priority to and the benefit of U.S. Provisional Application No. 63/579,614, filed on Aug. 30, 2023. The aforementioned application of which is incorporated herein by reference in its entirety.

### TECHNICAL FIELD

This document describes techniques for predicting trajectory of a vehicle and, in particular, predicting trajectory at an intersection.

### BACKGROUND

In computer-assisted vehicle driving such as autonomous driving, the vehicle moves from a current position to a next position by using information processed by an on-board computer. Users expect the computer-assisted driving operation to be safe under a variety of road conditions.

### SUMMARY

Various embodiments disclosed in the present document may be used to predict trajectory of a vehicle. In some embodiments, complex road conditions such as vehicles approaching or leaving a traffic intersection may be handled using a surrounding-away technique described herein.

In one example aspect, a method for predicting vehicle trajectory is disclosed. The method includes receiving information indicative of a surrounding environment of a vehicle, receiving a history of vehicle trajectories, determining learned patterns by separately operating a first encoder on the surrounding information and a second encoder on the history of vehicles trajectories, and determining one or more predicted future trajectories for the vehicle based on the learned patterns.

In another aspect, another method is disclosed. The method includes operating a scene encoder on an environmental representation surrounding a vehicle; concatenating an output of the scene encoder with a history trajectory; applying a sequence encoder to a result of the concatenating; refining and output of the sequence encoder based on the history trajectory; and generating one or more predicted future trajectories by operating a decoder on an output of the refining.

In yet another aspect, an apparatus for vehicle trajectory prediction is disclosed. The apparatus comprises one or more processors configured to implement any of above-recited method.

In yet another aspect, a computer storage medium having code stored thereon is disclosed. The code, upon execution by one or more processor, causes the processor to implement a method described herein.

The above and other aspects and their implementations are described in greater detail in the drawings, the descriptions, and the claims.

### BRIEF DESCRIPTION OF THE DRAWINGS

FIG. 1 shows a block diagram of an example vehicle ecosystem for autonomous driving technology according to some embodiments of the present document.

FIG. 2 is a flowchart for an example method of trajectory prediction.

FIG. 3 is a flowchart for an example method of trajectory prediction.

FIG. 4A-4D depict an example of environment depiction at a time step.

FIG. 5 shows an example workflow for a location aware position prediction method.

FIG. 6A shows an example of environment of a vehicular operation. The target vehicle is located at the left turn lane (center of the bottom of the image). Surrounding NPC are colored based on their motion energy (size times velocity squared).

FIG. 6B depicts an example scenario in which a target vehicle is depicted near center of the image along with history information.

FIG. 6C shows an example representation at a latest timestamp.

FIG. 7 depicts graphs of performance observed during some simulation experiments.

FIG. 8 depicts graphs of performance of one example prediction algorithm.

FIG. 9 is a histogram of performance result examples.

FIG. 10A and 10B depict a “stop at traffic” scenario.

FIG. 11 depicts a turning scenario.

FIG. 12A and 12B represent a lane change scenario.

FIG. 13 depicts a lane curvy lane scenario.

FIG. 14 is a graph depicting example of displacement error at each prediction time step.

FIG. 15A-15D depict an illustration of model results under different scenarios. Here, FIG. 15A depicts an example of driving straight. FIG. 15B depicts an example of turning. FIG. 15C depicts a lane change example. FIG. 15D depicts a stopping for traffic example.

### DETAILED DESCRIPTION

Section headings are used in the present document for case of cross-referencing and improving readability and do not limit scope of disclosed techniques. Furthermore, various image processing techniques have been described by using examples of self-driving vehicle platform as an illustrative example, and it would be understood by one of skill in the art that the disclosed techniques may be used in other operational scenarios also (e.g., video games, traffic simulation, and so on.).

### 1. INITIAL DISCUSSION

The thriving autonomous vehicle (AV) technology is gaining more and more public attention. To safely interact with surrounding environment, AVs are supposed to demonstrate remarkable performance to accurately predict trajectories of surrounding vehicles, so as to avoid potential collisions and risks. In addition to safety concerns, accurate trajectory prediction on surrounding vehicles also enhances the performance of model predictive control (MPC) for autonomous vehicles. These benefits making vehicle trajectory prediction an essential task when entering the era of next generation transportation systems. Although vital, vehicle trajectory prediction, especially prediction for long look-ahead time, can be challenging due to the rapidly changing surrounding environment of vehicles and complex nature of driving behavior, which can be greatly affected by a number of factors, including driver's personality, road curvature, weather, traffic rules, etc.

The present document disclosed techniques for predicting vehicle trajectories under one of the most challenging driving environment: intersections, where 50% of total crashes happen. In this document we propose a deep learning-based approach, called surrounding aware prediction intelligence, SAPI, to predict vehicle trajectories at intersections within long look-ahead time. Through a proposed environment representation strategy, SAPI incorporates real-time map, right-of-way and surrounding vehicle dynamics information in an abstract way. History trajectory of target vehicle is also used as one of the model inputs. Two encoders are introduced based on convolutional neural networks CNN and recurrent neural networks RNN in SAPI to learn patterns from surrounding environment and trajectory features separately. A refiner is proposed to refine the learned patterns by bridging outputted context patterns of encoder and raw history trajectory, conducting a look-back operation to further make the use of history information. A decoder is then used in the work to decode learned patterns and generate predicted future trajectories.

Unlike existing work that exhaustively enumerating factors that may affect driving behavior, or modeling a certain type of factors, e.g., vehicle interactions, SAPI separates information into two main types, e.g., surrounding environment and status of the target vehicle, and use an abstract environment representation strategy to encode surrounding environment. We show that the proposed model gains promising performance on a proprietary dataset collected by autonomous vehicles at variety of real-world intersections in Arizona, USA, and outperforms benchmark methods. When predicting future 6-second vehicle trajectory, average displacement error ADE of the proposed model is 1.84 m and final displacement error FDE is 4.32 m. Considering the average vehicle length, which is around 4.2 m, the proposed model demonstrates good performance. The proposed model demonstrates good performance in critic driving scenarios. For example, even though the traffic light information is not included in training data, the model can still anticipate driving intention and get accurate predictions by learning from surrounding traffic. The proposed model is computationally light weight. Even though the number of parameters is fewer than the benchmark method, it still shows significantly better performance in terms of average displacement error ADE and final displacement error FDE along the prediction horizon, which can be desirable for real-world applications.

Some embodiments use a highly accurate prediction pipeline for vehicle trajectory prediction in local intersection regions, with the emphasis on surrounding non player characters NPCs of the ego vehicles. In general, when predicting trajectory of an agent, two types of information are important:
History trajectory information, which is typically a time-dependent sequence of cartesian coordinates.
Surrounding dynamic environment, including map information, surrounding agent information and so on.

To represent the surrounding dynamic environment of an agent, the motivation is to use an energy-based encoding to represent the legally driving area of the NPC and its surrounding agents in an image at each history timestamp. For map information, if we give a legally reachable area a lower energy, and represent other places with higher energy, based on Lyapunov's theory, the system will have the intention to move towards the lower energy area, in order to minimize the total energy of that system. That representation can provide the information of “where can I go” for the target vehicle. For surrounding vehicle dynamics, we utilize the motion energy of an npc and conduct some computations to encode the energy-based dynamics and plot them in the feature image of a time stamp. The higher the motion energy is, the less likely the target to hit that position in the environment representation.

Current work focusing on vehicle trajectory prediction can be summarized into two categories, i.e., physics-based models and learning-based models. Physics-based models usually formulate the problem from physics' point of view, for example, developing robust motion models, etc., while learning based models focus more on learning patterns of history trajectory of a target vehicle and its surrounding environment. In this section we review existing literature on vehicle trajectory prediction, with the emphasis on learning-based models, which is the category the proposed work belongs to.

Physics-based models are mainly developed through manipulating motion models or state filtering strategies. One implementation proposed a vehicle trajectory prediction method based on motion model and maneuver recognition. It combined trajectories predicted by constant yaw rate and acceleration motion model, and trajectories predicted by maneuver recognition. By taking benefits of both models, it showed better prediction accuracy for both short-term and long-term predictions. One implementation proposed a vehicle trajectory prediction algorithm for adaptive cruise control (ACC) purpose. It used the yaw rate of the target vehicle and road curvature information, and then formulated future vehicle dynamics through a transfer function of integration on velocity and acceleration. One implementation uses a dead reckoning system and conducted vehicle trajectory prediction based on Kalman filter, where vehicle dynamics were computed through constant velocity and acceleration models. Physics-based models are generally easier to set up, however, their performance may largely be affected by prediction horizon. Complex nature of driving behaviors and challenges brought by dynamic driving environment can make physics-based models only suitable for short-term trajectory prediction.

With advancements in machine learning and artificial intelligence in past decades, learning-based methods become the mainstream with respect to the topic. One implementation proposed a deep learning model for vehicle trajectory prediction based on convolutional social pooling. It used a long short-term memory (LSTM) encoder-decoder model along with convolutional social pooling to learn inter-dependencies between vehicles. It showed that the model demonstrated good performance on public datasets. However, as indicated by authors, it used purely vehicle tracks, which negatively affected prediction performance. One implementation proposed a two-level vehicle trajectory prediction framework for urban driving scenarios. It used a LSTM network to anticipate vehicle's driving policy, i.e., driving forward, yield, turning left, or turning right, and then generated vehicle trajectories through optimization by minimizing the cost of driving context. It demonstrated good flexibility under different driving scenarios. However, it assumed deterministic reasoning based on one selected policy, which harmed its prediction accuracy. One implementation proposed a vehicle trajectory prediction method based on generative adversarial networks (GAN). It modeled vehicle interactions in a social context and generated the most acceptable future trajectory. It indicated that the proposed method was able to predict different traffic maneuvers like overtaking, merging, etc. One implementation uses a deep CNN-based model to predict vehicle trajectories. It used detailed surrounding information and compressed them into raster images. After that the information was encoded and learned by a constructed single deep CNN and decoded into future trajectories. Through a multi-model strategy, authors demonstrated that the method showed good performance in terms of left-turn, straight and right-turn tasks. However, due to the model setting, the prediction results can be significantly affected by the number of modes, requiring the model to be carefully calibrated, and large computational resources were needed to train the model. One implementation proposed a convolutional model to predict driving behavior with semantic interactions. It represented environment and semantic scene context into occupancy grid maps with 20 channels. Using an encoder-decoder pair, future trajectories were predicted along with probability distributions. It indicated that the model outperformed linear and Gaussian mixture models and can create diverse samples for planning applications. However, exhaustively introduce as much information as possible into the model can largely increase the computation burden, and makes the model require significant overhead processing time during real-world applications.

In contrast to existing literature, in disclosed embodiments, the proposed SAPI model may not need to exhaustively exploit available information, nor to make rigid assumptions on vehicle motion. It uses an abstract way to represent surrounding driving environment and focuses on learning patterns from the environment representation and history trajectory.

### 2. EXAMPLE VEHICLE ECOSYSTEM FOR AUTONOMOUS DRIVING

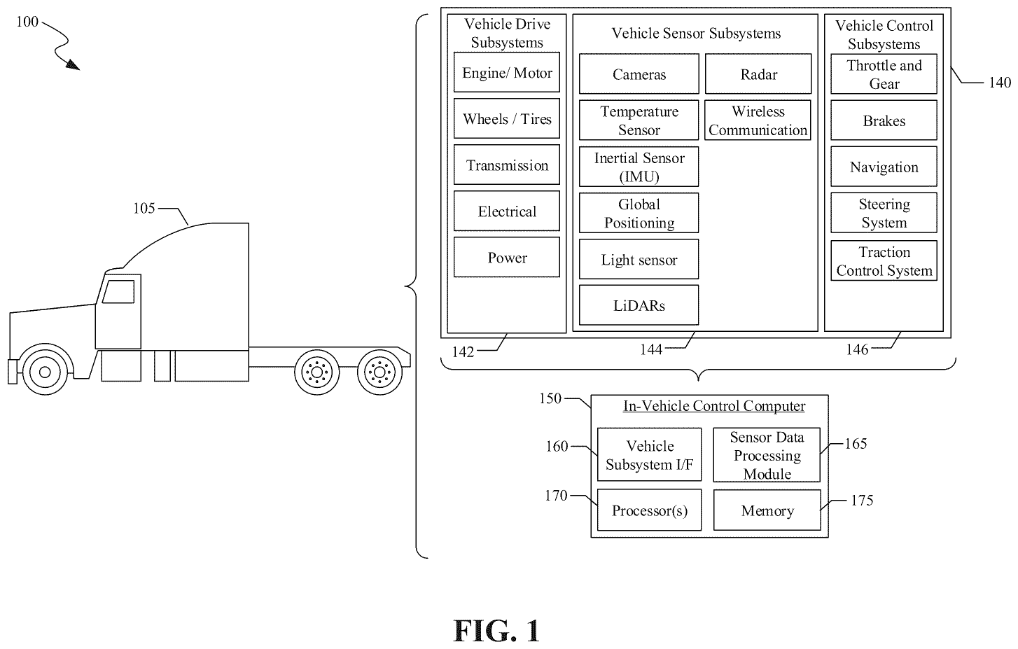

FIG. 1 shows a block diagram of an example vehicle ecosystem 100 for autonomous driving LiDAR technology. The vehicle ecosystem 100 may include an in-vehicle control computer 150 is located in the autonomous vehicle 105. The sensor data processing module 165 of the in-vehicle control computer 150 can perform signal processing techniques on sensor data received from, e.g., one or more of a camera, a light detection and ranging (LiDAR) sensor, a positioning sensor, a radar sensor, an ultrasonic sensor, or a mapping sensor, etc., of (e.g., on or in) the autonomous vehicle 105 so that the signal processing techniques can provide characteristics of objects located on the road where the autonomous vehicle 105 is operated in some embodiments. The sensor data processing module 165 can use at least the information about the characteristics of the one or more objects to send instructions to one or more devices (e.g., motor in the steering system or brakes) in the autonomous vehicle 105 to steer and/or apply brakes.

As exemplified in FIG. 1, the autonomous vehicle 105 may be a truck, e.g., a semi-trailer truck. The vehicle ecosystem 100 may include several systems and components that can generate and/or deliver one or more sources of information/data and related services to the in-vehicle control computer 150 that may be located in an autonomous vehicle 105. The in-vehicle control computer 150 can be in data communication with a plurality of vehicle subsystems 140, all of which can be resident in the autonomous vehicle 105. The in-vehicle computer 150 and the plurality of vehicle subsystems 140 can be referred to as autonomous driving system (ADS). A vehicle subsystem interface 160 is provided to facilitate data communication between the in-vehicle control computer 150 and the plurality of vehicle subsystems 140. In some embodiments, the vehicle subsystem interface 160 can include a controller area network (CAN) controller to communicate with devices in the vehicle subsystems 140.

The autonomous vehicle (AV) 105 may include various vehicle subsystems that support the operation of the autonomous vehicle 105. The vehicle subsystems may include a vehicle drive subsystem 142, a vehicle sensor subsystem 144, and/or a vehicle control subsystem 146. The components or devices of the vehicle drive subsystem 142, the vehicle sensor subsystem 144, and the vehicle control subsystem 146 as shown as examples. In some embodiment, additional components or devices can be added to the various subsystems. Alternatively, in some embodiments, one or more components or devices can be removed from the various subsystems. The vehicle drive subsystem 142 may include components operable to provide powered motion for the autonomous vehicle 105. In an example embodiment, the vehicle drive subsystem 142 may include an engine or motor, wheels/tires, a transmission, an electrical subsystem, and a power source.

The vehicle sensor subsystem 144 may include a number of sensors configured to sense information about an environment in which the autonomous vehicle 105 is operating or a condition of the autonomous vehicle 105. The vehicle sensor subsystem 144 may include one or more cameras or image capture devices, one or more temperature sensors, an inertial measurement unit (IMU), a Global Positioning System (GPS) device, a plurality of light detection and ranging radar LiDARs, one or more radars, one or more ultrasonic sensors, and/or a wireless communication unit (e.g., a cellular communication transceiver). The vehicle sensor subsystem 144 may also include sensors configured to monitor internal systems of the autonomous vehicle 105 (e.g., an O₂ monitor, a fuel gauge, an engine oil temperature, etc.,). In some embodiments, the vehicle sensor subsystem 144 may include sensors in addition to the sensors shown in FIG. 1.

The IMU may include any combination of sensors (e.g., accelerometers and gyroscopes) configured to sense position and orientation changes of the autonomous vehicle 105 based on inertial acceleration. The GPS device may be any sensor configured to estimate a geographic location of the autonomous vehicle 105. For this purpose, the GPS device may include a receiver/transmitter operable to provide information regarding the position of the autonomous vehicle 105 with respect to the Earth. Each of the one or more radars may represent a system that utilizes radio signals to sense objects within the environment in which the autonomous vehicle 105 is operating. In some embodiments, in addition to sensing the objects, the one or more radars may additionally be configured to sense the speed and the heading of the objects proximate to the autonomous vehicle 105. The laser range finders or LiDARs may be any sensor configured to sense objects in the environment in which the autonomous vehicle 105 is located using lasers or a light source. The cameras may include one or more cameras configured to capture a plurality of images of the environment of the autonomous vehicle 105. The cameras may be still image cameras or motion video cameras. The ultrasonic sensors may include one or more ultrasound sensors configured to detect and measure distances to objects in a vicinity of the AV 105.

The vehicle control subsystem 146 may be configured to control operation of the autonomous vehicle 105 and its components. Accordingly, the vehicle control subsystem 146 may include various elements such as a throttle and gear, a brake unit, a navigation unit, a steering system and/or a traction control system. The throttle may be configured to control, for instance, the operating speed of the engine and, in turn, control the speed of the autonomous vehicle 105. The gear may be configured to control the gear selection of the transmission. The brake unit can include any combination of mechanisms configured to decelerate the autonomous vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more predetermined maps so as to determine the driving path for the autonomous vehicle 105. The steering system may represent any combination of mechanisms that may be operable to adjust the heading of autonomous vehicle 105 in an autonomous mode or in a driver-controlled mode.

In FIG. 1, the vehicle control subsystem 146 may also include a traction control system (TCS). The TCS may represent a control system configured to prevent the autonomous vehicle 105 from swerving or losing control while on the road. For example, TCS may obtain signals from the IMU and the engine torque value to determine whether it should intervene and send instruction to one or more brakes on the autonomous vehicle 105 to mitigate the autonomous vehicle 105 swerving. TCS is an active vehicle safety feature designed to help vehicles make effective use of traction available on the road, for example, when accelerating on low-friction road surfaces. When a vehicle without TCS attempts to accelerate on a slippery surface like ice, snow, or loose gravel, the wheels can slip and can cause a dangerous driving situation. TCS may also be referred to as electronic stability control (ESC) system.

Many or all of the functions of the autonomous vehicle 105 can be controlled by the in-vehicle control computer 150. The in-vehicle control computer 150 may include at least one processor 170 (which can include at least one microprocessor) that executes processing instructions stored in a non-transitory computer readable medium, such as the memory 175. The in-vehicle control computer 150 may also represent a plurality of computing devices that may serve to control individual components or subsystems of the autonomous vehicle 105 in a distributed fashion. In some embodiments, the memory 175 may contain processing instructions (e.g., program logic) executable by the processor 170 to perform various methods and/or functions of the autonomous vehicle 105, including those described for the sensor data processing module 165 as explained in this patent document. For example, the processor 170 of the in-vehicle control computer 150 and may perform operations described in this patent document.

The memory 175 may contain additional instructions as well, including instructions to transmit data to, receive data from, interact with, or control one or more of the vehicle drive subsystem 142, the vehicle sensor subsystem 144, and the vehicle control subsystem 146. The in-vehicle control computer 150 may control the function of the autonomous vehicle 105 based on inputs received from various vehicle subsystems (e.g., the vehicle drive subsystem 142, the vehicle sensor subsystem 144, and the vehicle control subsystem 146).

### 3. EXAMPLE METHODS FOR PREDICTING TRAJECTORIES

As further discussed throughout the present document, trajectory prediction may be performed using the SAPI framework described herein.

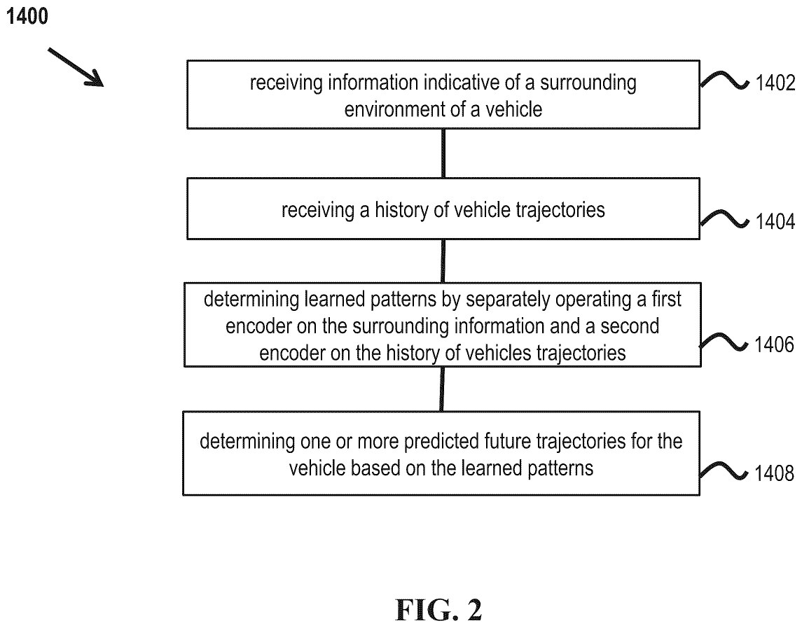

For example, as depicted in FIG. 2, a method 1400 of predicting trajectory of a vehicle includes receiving (1402) information indicative of a surrounding environment of a vehicle receiving (1404) a history of vehicle trajectories; determining (1406) learned patterns by separately operating a first encoder on the surrounding information and a second encoder on the history of vehicles trajectories; and determining (1408) one or more predicted future trajectories for the vehicle based on the learned patterns. The method 1400 may use learning models, environmental representations, etc. as disclosed in the present document.

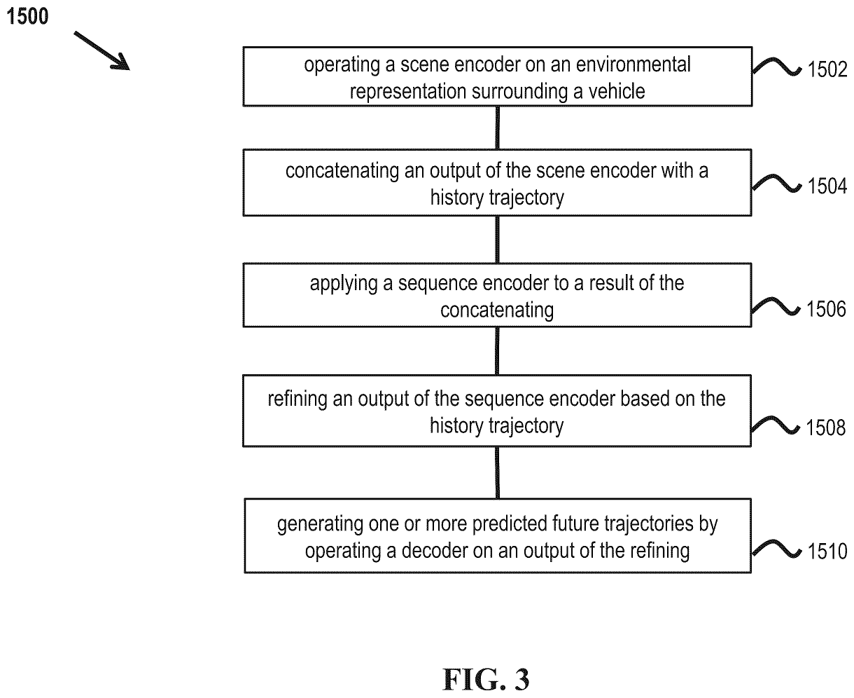

FIG. 3 shows another method 1500 of predicting vehicle trajectory. The method 1500 includes operating (1502) a scene encoder on an environmental representation surrounding a vehicle; concatenating (1504) an output of the scene encoder with a history trajectory; applying (1506) a sequence encoder to a result of the concatenating; refining (1508) an output of the sequence encoder based on the history trajectory; and generating (1510) one or more predicted future trajectories by operating a decoder on an output of the refining. Additional features are disclosed throughout the present document.

Additional details about the above-described methods are provided throughout the present document.

### 4. EXAMPLES OF LOCAL PREDICTION MODELS

In this work we investigate the problem of vehicle trajectory prediction at intersections, with the information of real-time high-definition (HD) maps, surrounding vehicle dynamics and history trajectory of a target vehicle. The proposed model encodes surrounding environment information and history positions of the target vehicle in past several seconds, learns motion patterns, and predicts the future trajectory of it. The problem can be formulated as follows: Assume Sₜ=(Sₜₓ, S_{ty}), Sₜₓ×S_{ty}∈ [symbol] ², is the position of the target vehicle at time t, and Eₜ is the representation of surrounding environment information at time t. With the history length of m time steps, the observed history sequence is Oₜ=((Sₜ₋ₘ₊₁, Eₜ₋ₘ₊₁), (Sₜ₋ₘ₊₂, Eₜ₋ₘ₊₂), . . . , (Sₜ, Eₜ)). The objective is to predict the future position of vehicles given desired prediction horizon n based on Oₜ, i.e., estimating Qₜ=(Sₜ₊₁, Sₜ₊₂, . . . , Sₜ₊ₙ). In this document we adopt m=12 and n=15, with time gap between two adjacent time steps being 0.4 seconds, which corresponds to 4.8-second history information, and predicting the trajectory in future 6 seconds.

### 5. EXAMPLES OF ENVIRONMENTAL REPRESENTATION

Driving behavior can be affected by numerous factors in its surrounding environment, including road geometry, surrounding traffic, weather, right-of-way, etc. Such factors are not able to be fully observed. Some embodiments may take into account two main types of surrounding environment information at each history time step: i) legally reachable arcas (LRAs) of a target vehicle and; ii) surrounding vehicle dynamics. To maintain relative spatial information, single-channel images are used to encode such information. Instead of directly drawing HD maps and surrounding vehicles on images similar to some existing work, an energy-based encoding is used to compute “energy weights” of each lane segment in the scene and also that of surrounding traffic. In a constructed single-channel image, the representation may be that the higher the pixel values, i.e., lighter colors, the lower the energy. Based on Lyapunov stability theorem, the system will have the intention to transit to states with lower energy, which reflects the intention of the target vehicle at a time step.

### 5.1 Legally Reachable Areas Examples

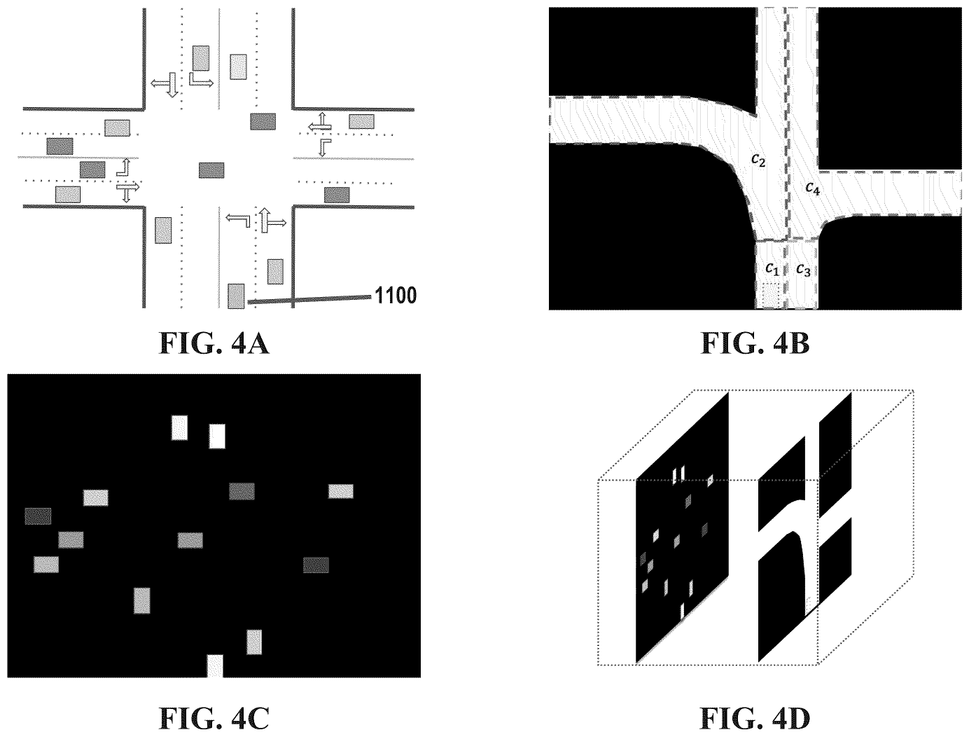

Right-of-way is one of the most basic rules that a vehicle needs to follow when driving, especially at intersection regions. It indicates future movement options of a vehicle, e.g., going straight, turning left or turning right. Based on the HD maps used in this work, road structures are formed by different lane segments. We query real-time surrounding lane segments of a vehicle in the intersection region. Based on right-of-way information, lane segments are divided into two types based on whether a segment can be legally reached from the current position of target vehicle at a time step or not. The detailed strategy is shown as follows. Given a vehicle at time step t, the LRAs C of the vehicle is defined as follows: i) Current lane segment c₁ that the target vehicle locates in; ii) lane segments c₂ that fall in the range if searching d meters forward from c₁; iii) neighbor lane segment c₃ if the vehicle is allowed to do left or right lane change at time t; iv) lane segments c₄ that fall in the range if searching d meters forward from c₃. Note that both c₂, c₃ and c₄ can contain multiple lane segments. c₁ and c₂ depict reachable areas if the vehicle continues driving forward in the future, while c₃ and c₄ show all potential regions the vehicle may reach in next few seconds if lane-change is allowed at time t. The LRAs at time t is then encoded by a single-channel bird-eye view image X₁ₜ, with the vehicle position be the mid-bottom of the image, depicting LRAs seen by the target vehicle at time t. When encoding, LRAs are assigned with pixel value 255, and 0 otherwise. FIG. 4B shows the illustration of the LRAs of driving environment in FIG. 4A, where white regions in the figure show LRAs at the investigated time step, depicting future movement options. Boxes in FIG. 4A are vehicles, and the greener the box is, the faster the vehicle drive. The mid-bottom of the image is the position of the target vehicle, which is depicted as a dashed gray box in FIG. 4B. Note that the dashed box and lane segment region borders are only used to demonstrate the settings of LRAs, and are not included in the model input.

Note that in this work traffic light information is not considered currently, however, such information can be easily integrated into the representation by utilizing right-of-way when available in the future. Based on the representation, the surrounding map information of a given target vehicle can be encoded through an abstract strategy based on right-of-way. Though not considered in this work, the presentation provides the flexibility to include other environment factors affecting right-of-way when available, e.g., traffic light status, real-time road closure information, etc., making the model adaptive for future applications.

### 5.2 Surrounding Vehicle Dynamics Examples

Surrounding traffic plays a significant role in affecting vehicles' future motion and intention. For each history time step, another single channel bird-eye view image X₂ₜ is introduced to represent surrounding traffic dynamics of a target vehicle. We introduce an encoding strategy of surrounding vehicle dynamics based on their motion energy. Assume the mass of a surrounding vehicle i in the scene is mᵢ′, and mᵢ′ is proportional to its size sᵢ, i.e., mᵢ′∝sᵢ. With the velocity of the vehicle vᵢₜ at time t, motion energy of i is calculated as

$${E}_{motion} = {}_{\underline{2}}^{1} {m}_{i}^{′} {v}_{it}^{2} , s . t . {E}_{motion} ∝ {s}_{i} {v}_{it}^{2} .$$

Then the pixel value of surrounding NPCs in the image is calculated through the distribution below:

$$pixel\_value = 255 * ( 1 - {e}^{- \frac{1}{0.01 {s}_{i} {v}_{it}^{2} + 1}} ) \qquad ( 1 )$$

Based on Eq. 1, in the representation image, pixels occupied by vehicles with greater motion energy will be encoded with a lower value (darker color). When drawing the bird-eye view (BEV) image, vehicles are presented as boxes, with the sizes depending on the real size of the corresponding vehicles. The target vehicle 1100 is located at the mid-bottom of the image, and surrounding vehicles are plotted based on the relative position to the target vehicle. FIG. 4C illustrates a representation example of surrounding traffic at the investigated time step of FIG. 4A, in which the target vehicle is located at mid-bottom of the image. Different grayness shows the motion energy difference, with the corresponding pixel values computed based on Eq. 1. Note that both road geometry (map) and surrounding vehicle positions are rotated based on the heading of the target vehicle at the corresponding time step, with the target vehicle heads upward.

### 5.3 Examples of Environment Representation as Model Input

Based on the aforementioned encoding strategy, by stacking X₁ₜ and X₂ₜ, the surrounding environment at time t of target vehicle is represented as a two-channel image as shown in FIG. 11D, i.e., Et=stack(X₁ₜ, X₂ₜ). Along with the target vehicle position Sₜ, the input sequence to the model can be formed by concatenating Et and Sₜ in past m time steps.

### 6. EXAMPLES OF MODEL ARCHITECTURE

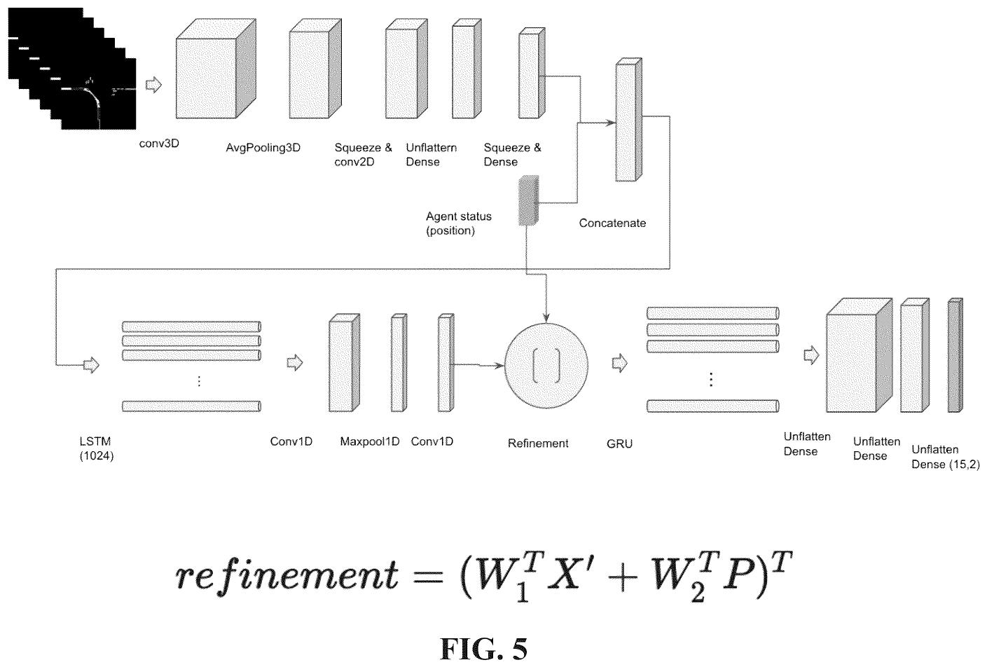

The general idea behind SAPI is to learn patterns from both history trajectory and the surrounding environment of a given target vehicle, so as to accurately predict its future position. The proposed model architecture of SAPI is shown in FIG. 5. The details of the architecture include the following:

### 6.1 Scene Encoder Examples

With m history time steps, the environment representation sequence is firstly learned by a CNN-based scene encoder. First of all, a 3D convolutional layer is applied directly on top of two-channel images, features are extracted by a 3D average pooling strategy. Followed by a squeeze and 2D convolution layer, the model further learns patterns from the environment representation. After that two fully connected layers are constructed, and the environment information is then encoded. The output of scene encoder is a tensor T₁ with shape (m, 3).

### 6.2 Sequence Encoder Examples

A sequence encoder is constructed to further learns patterns along with history trajectory. After learned by the scene encoder, the result environment encoding T₁ is concatenated with the history trajectory S=(Sₜ₋ₘ₊₁, Sₜ₋ₘ₊₂, . . . , St), resulting a tensor T₂ with shape (m, 5). At the beginning, the sequence encoder learns sequence-related features in T₂ through an LSTM-based RNN, and passes it to a 1D convolutional layer. Followed by a maxpooling strategy and an additional 1D convolutional layer, patterns are learned into a feature tensor T₃.

### 6.3 Refiner Examples

History trajectory information reflects past driving patterns of vehicles. To fully utilize the history trajectory information, a refiner is defined in SAPI. By creating a short-cut between the raw history trajectory input and T₃, the actor refines the learned patterns by looking back to the raw history trajectory. The actor is defined in Eq. 2.

$${T}_{4} = {( {W}_{1}^{T} S + {W}_{2}^{T} {T}_{3} )}^{T} \qquad ( 2 )$$

Where W₁ and W₂ are refinement weights subject to be learned.

### 6.4 Decoder Examples

A decoder is then introduced to decode aforementioned learned patterns into a future trajectory. At the beginning, a GRU-based RNN is applied on refined features. Then two fully connected layers are constructed to further decoding features. Finally, the future trajectory is predicted with an additional dense layer.

In various embodiments, the decoder may be configured to include multiple layers that progressively perform decoding operation to generate the final results.

### 7. EXAMPLES OF MODEL SETTING AND EVALUATION

Based on the aforementioned model architecture, the proposed model in one example implementation has 5,000,329 parameters in total. To better measure sequence-related errors during training, we use the loss function as shown in Eq. 3, which is a Huber loss.

$$Loss = {\sum }_{i = 1}^{n} \{ \begin{matrix}\frac{1}{2 r} {( {g}_{i} - {p}_{i} )}^{2} & if \vert {g}_{i} - {p}_{i} \vert < r \\ \vert {g}_{i} - {p}_{i} \vert < r & otherwise\end{matrix} \qquad ( 3 )$$

where r is a pre-defined threshold, gᵢ and pᵢ are the ground truth position and predicted position at i-th time step respectively, and n is the prediction horizon. We evaluate the performance of the model based on following metrics: i) ADE: The displacement error average on all time steps for 6-second prediction horizon on all samples in the test set; ii) 6 s FDE: The displacement error at the final time step; iii) 4 s FDE: The displacement error at 4th second in the future, showing the performance on mid-range prediction; iv) standard deviation of displacement errors at 4th second (4 s FDE std) and 6th second (6 s FDE std) on the whole test set. We also compare the performance of the model with following approaches:
1) Resnet: Resnet is classic but powerful deep learning model, demonstrating good and robust performance in different fields. It has been adopted directly, or as a backbone, to conduct vehicle trajectory prediction in lots of work, and achieved good performance. In this work, we adopt Resnet34(v2) as a benchmark. The model contains 34 convolutional layers. The environment representation is firstly learned by Resnet. Then features are concatenated with agent history trajectory. Finally, features are decoded by two fully connected layers. Note that this benchmark model contains 21,771,260 parameters in total, which is approximately four times of the proposed model.
2) Vanilla LSTM: LSTM is a popular method for learning patterns in time-series data. In recent years, some researchers use it for vehicle trajectory prediction. The benchmark model used in this work is a vanilla LSTM model with 1024 hidden units, and learns patterns directly on agent history trajectory, and decoded by two fully connected layers.
3) SAPI without map information: We consider the SAPI without the representation of LRAs.
4) SAPI without surrounding traffic: We consider the SAPI without surrounding vehicle dynamics information.

### 8. ADDITIONAL EMBODIMENT EXAMPLES

In some implementations, legally reachable areas/lanes are encoded with pixel value 255 (white), while illegal regions are encoded with pixel value 0. In the single channel image, surrounding NPC dynamics are also included. Each NPC is represented by a box in the single channel image, with the size be their actual size ((This can be updated to 3 channel images, with legally reachable area and surrounding agent dynamics in different channels). This encoding can also be extended when traffic light information is available (simply use right-of-way). The pixel value at that NPC position is computed based on its motion energy. Assuming the mass of an npc is proportional to the size of a vehicle, the motion energy is proportional to size*v\hat{ }2. Then, using a Bolztman-like distribution, the value is then scaled to [0, 255] to get the pixel value of region occupied by the npc: 255*(1−e\hat{ }(−1/(0.01 sv\hat{ }2+1))). When drawing the environment representation image, first the legally reachable area is drawn, and then redraw the vehicle dynamics on top of it. Some of the environment representations are as follows.

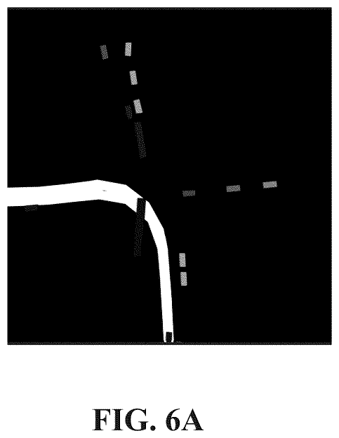

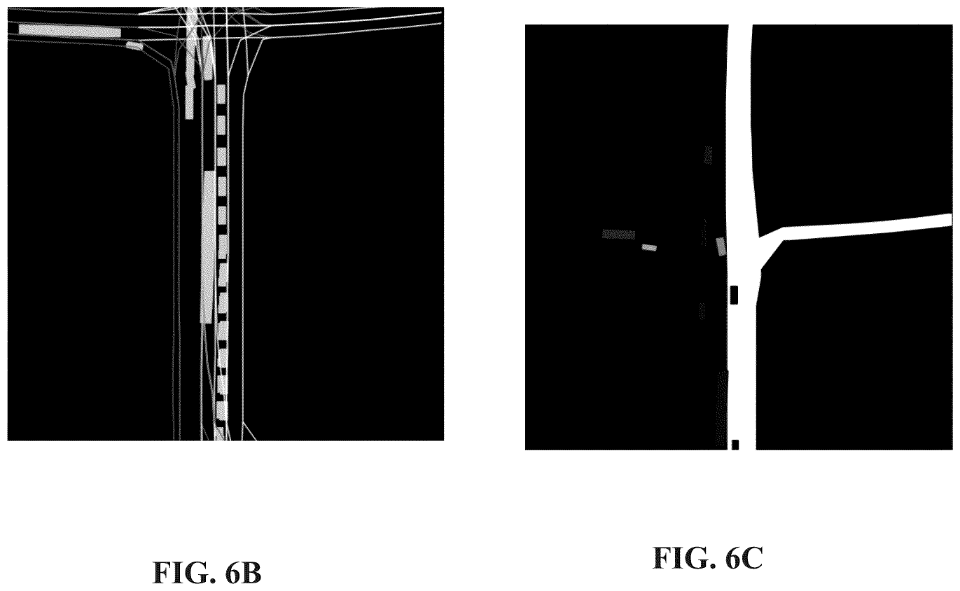

In FIG. 6A, the target vehicle is located at the left turn lane (center of the bottom of the image). Surrounding NPC are colored based on their motion energy (size times velocity squared).

FIG. 6B depicts an example scenario in which a target vehicle is depicted near center of the image along with history information.

FIG. 6C shows an example representation at a latest timestamp. Here, the target vehicle is about to enter an intersection.

### 8.1 Example Parameter Details

In some embodiments, the input to the model includes two components (also called channels):
i) NPC agent status sequence, e.g., position (x,y);
ii) a sequence of energy mapping images representing the surrounding environment and legally reachable regions (right-of-way).

When representing the surrounding environment, a single channel image is plotted, with the target NPC located at the mid-bottom of the image. In the setting, lanes without ROW are assumed to hold infinite energy (highest), while lanes with ROW hold 0 energy (lowest). The energy of vehicles is related to their velocity (motion energy). Note that relative velocity is not used in the current model. As it brings bias to the representation due to the different movement of agents and makes the representation not general.

The energy of an NPC is then scaled to interval such as [0,255]. For road/lanes: ROW has pixel value 255 (white), without ROW corresponding to 0 (black). The pixel value of agents can be scaled to the interval through a Boltzman-like distribution.

The design for this environment representation is that, in a general framework to:
Know where the target vehicle is from (history)
Gain insights on where the vehicle can go (future reachable regions)
Depict surrounding agent dynamics

### 8.2 Example Network Details

The image sequence (for example, containing 12 scenes from 12 timestamps) is firstly learned by an CNN-based encoder; then the learned pattern P is concatenated with agent status (position) X to be F1; after that a second encoder, which is based on long short-term memory LSTM and CNN, is used to further learn time-related patterns, and output corresponding feature patterns F2. A refinement step is then used to perform refinement and create a shortcut between the learned features and raw agent status input. The details of the refinement step are O=WX+W′F2, where W and W′ are weights to be learned. The output shape of the refinement step is m*n, where m is the time dimension of input sequence, and n is the time dimension of label sequence.

In various embodiments, instead of a linear weighting, other refinements (e.g., non-linear or interdependent) may be used.

### 8.3 Training

The model is trained on 2 2080-Ti GPUs on Tuyaco. One training config uses optimizer: adagrad, a learning rate of 0.007, and Batch_size: 64. Although these parameters are used for providing test results discussed below, it would be appreciated that the parameters may be set different by one of skill in the art.

### 8.4 Results

A training time of around 5600 s on 80000 samples/epoch with the GPU configuration above was used with model size: 21.57 MB.

The results were as follows: Model ADE 5 s: 1.8265419; Model FDE 5 s: 3.7349317; ULM FDE 5 s: 5.9697943; On-board predictor FDE 5 s: 4.831051; Model ADE 6 s: 2.2616537.

The table below shows a comparison between one embodiment according to disclosed techniques and some other industry-standard methods.

| Model name | Performance |
|---|---|
| Our model | 5 s ade/fde: 1.82/3.73 m, 6 s ade/fde: |
| | 2.26/5.28 m, 3 s fde is around 1.2 m |
| multipath | 6 s ADE: 4.01 m Nuscenes/2.91 in |
| | Uber dataset |
| One industry | 6 s: ~5 m in their dataset (no |
| example | approaching segments) |
| Another industry | FDE around 3 m for 3 s prediction |
| example | |

The table below compares relative errors of proposed embodiments.

| Model | 0.4 s | 0.8 s | 1.2 s | 1.6 s | 2.0 s | 2.4 s | 2.8 s | 3.2 s | 3.6 s | 4.0 s | 4.4 s | 4.8 s | 5.2 s | 5.6 s | 6.0 s |
|---|---|---|---|---|---|---|---|---|---|---|---|---|---|---|---|
| Proposed | 0.273 | 0.456 | 0.636 | 0.848 | 1.112 | 1.378 | 1.687 | 1.986 | 2.312 | 2.636 | 3.178 | 3.506 | 4.013 | 4.612 | 5.281 |
| On- | 0.196 | 0.381 | 0.588 | 0.824 | 1.107 | 1.441 | 1.823 | 2.256 | 2.737 | 3.271 | 3.856 | 4.489 | 5.172 | 5.973 | 6.856 |
| board | | | | | | | | | | | | | | | |
| predictor | | | | | | | | | | | | | | | |
| ULM | 0.002 | 0.222 | 0.469 | 0.777 | 1.150 | 1.591 | 2.092 | 2.657 | 3.283 | 3.971 | 4.723 | 5.534 | 6.411 | 7.413 | 8.515 |

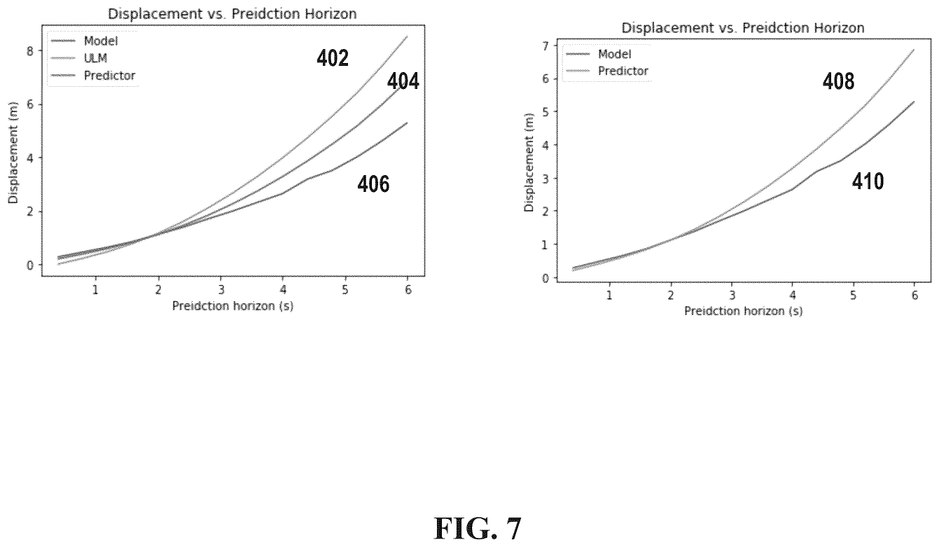

FIG. 7 shows performance curves comparing model and existing on-board predictor. On the left graph (displacement on vertical axis and prediction horizon on horizontal axis), ULM displacement is depicted by 402, predictor error is shown by 404 and displacement error is shown by curve 406. In the right graph, the displacement vs prediction horizon is depicted by curve 408 for predictor and 410 for the proposed model. It may be seen that both have similar performance in the first 2 seconds, however, as prediction horizon increases, the model outperforms on-board predictor in terms of long horizon prediction.

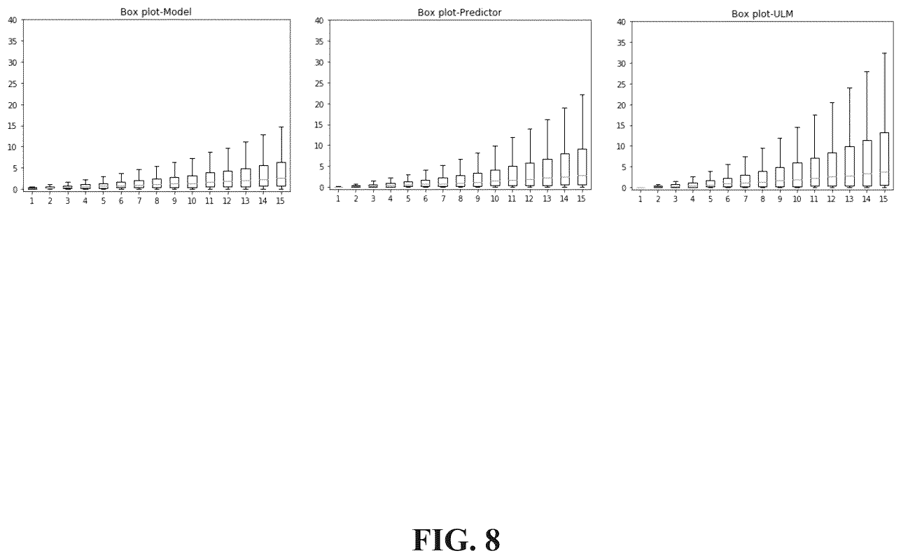

FIG. 8 shows the box plots regarding model (502), on-board predictor (504) and uniform linear motion (ULM) predictor (506). The model has the narrowest range according to the plot, demonstrating a robust performance in 6-second prediction. Here, horizontal axis represents time, and vertical axis represents displacement error.

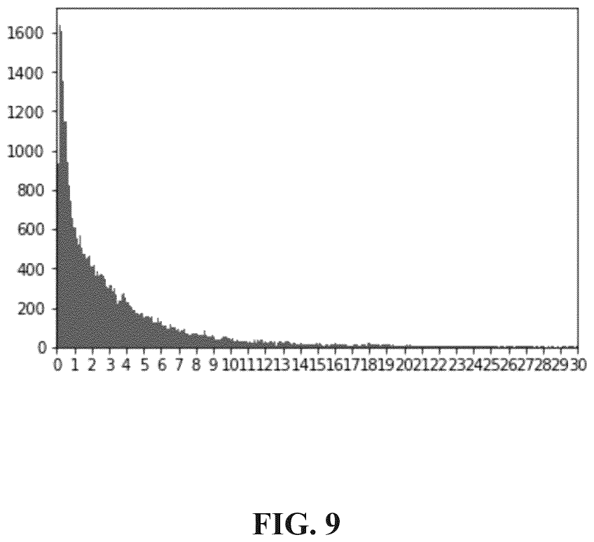

FIG. 9 histogram shows the FDE statistics on all test samples. The 6-second FDE

majority/peak of the model prediction is very close to 0, demonstrating the high performance of the proposed model.

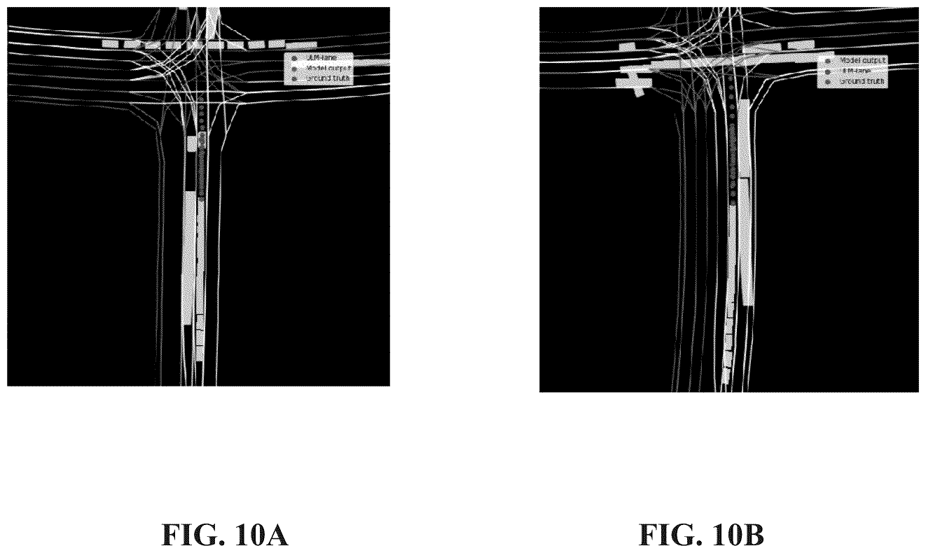

FIGS. 10A and 10B depict a channel image used for the “Stop at Traffic” scenario where the target vehicle is expected to come to a stop upon encountering traffic or red light ahead.

FIG. 11 depicts a turning scenario where the target vehicle is in a turning lane.

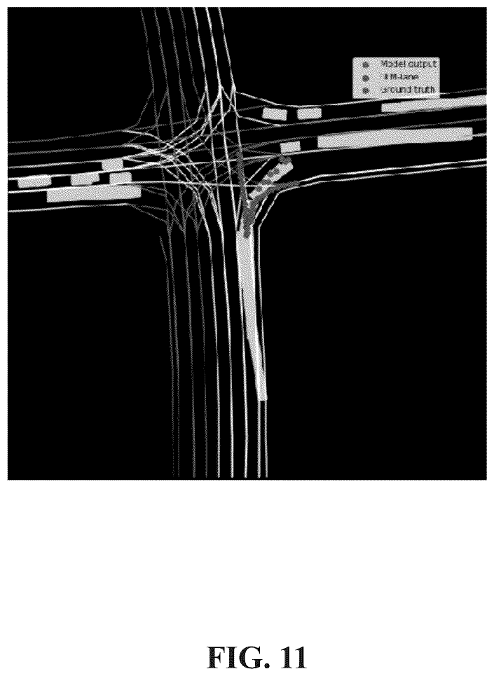

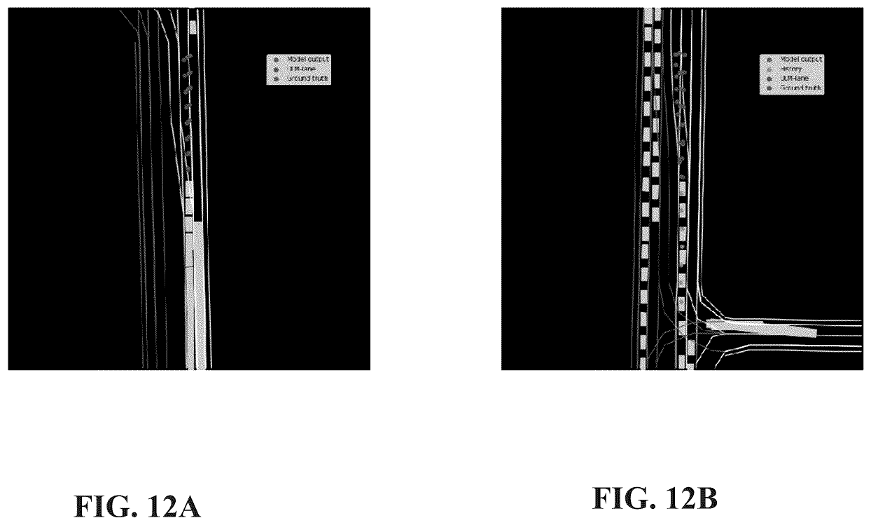

FIG. 12A shows the scenario of a lane change performed by the target vehicle while driving along a relatively straight road. FIG. 12B shows a scenario where the target vehicle changes lane during a situation of a road junction (T-junction).

FIG. 13 depicts the scenario of traveling along a curvy lane, e.g., an entrance ramp to a highway.

### 9. A DISCUSSION OF EXAMPLE ADVANTAGE

The model outperforms the on-board predictor in 6-second prediction and provides a narrower FDE error range according to the box plots. The model has good performance regarding different scenarios, including driving on curvy/straight roads, predicting lane change behavior, and it can learn surrounding traffic patterns to make more accurate predictions.

The training process is robust, and not sensitive to hyper-parameters, i.e., easy to converge to near-optimal among the loss surface. The proposed model uses a learning rate 0.007, however, different learning rates were tested, and they converge to approximate final loss values. The model is also light-weighted: the trained model is only 20 MB, which benefits deployments.

### 10. FURTHER EMBODIMENT FEATURES

In some embodiments, smoothness improvements may be made to the above disclosed example. The model uses a setting that predicts future trajectories in continuous space. During training, the goal of the model is to generate a predicted trajectory that is as closer to ground truth as possible. If such trajectories are not generated from physics law, they may not be smooth, especially during turning scenarios. To resolve the issue, some embodiments may use a regularization term in loss, to provide a penalty if the acceleration in predicted trajectory is too large. However, this poses an indirect impact to the final result, and based on the observation, may not help much in terms of reduction in displacement error. The second strategy is to improve the model performance, which is one of the preferred strategies. Based on the observation, once the model performance is improved, the smoothness issue is improved along with it. The third strategy can be applying a post-processing module (smoothing function) to the model output and process the predicted trajectory to a smooth one. Using this strategy, a smoothness metric may be added to the training loss and use it as a penalty/regularization term, which can be calculated as a dimensionless jerk.

This can directly force the model to learn a smooth trajectory. This strategy is different from using the acceleration threshold as a regularization turn, as even if the acceleration of the predicted trajectory is within the threshold, the model can still output an unsmooth trajectory. However, using a smoothness metric can avoid that drawback, as it evaluates smoothness directly.

In some embodiments, the above-disclosed model may be modified to improve its robustness. The robustness of the model can be further improved by training on more data. For acceptable results, the model only trained with less than 100k data samples. The performance of supervised learning models can be improved with more training data. In addition, it may be beneficial if the model is trained on a more balanced (unbiased) dataset. It does not include much data from rarely seen scenarios, for example, scenes from T-type intersections are rare in the training dataset, which may result in poor performance when predicting trajectory under this scenario. In some models, the training data may use accurate traffic light information (e.g., collected from specific locations at specific streets).

In the environment representation setting, a model that uses a single channel image to encode and represent map information and surrounding dynamics may have the drawback that the pixel values of surrounding vehicle dynamics can overwrite the legally reachable area pixel value. This might cause a problem that if the surrounding vehicle dynamics is very large, it will be marked as dark (0), which is the same as non-reachable areas. That may cause the failure case that predicts that the target vehicle does not stop for red light. One solution is to represent map information and surrounding vehicle dynamics in two different channels. However, according to the experiment, the training time may increase 2 times, and result in similar performance on the test set. Though it can take longer to train and generate approximate performance, 3-channel setting may help improve the model performance on some certain (rare) scenarios like the aforementioned failure case. Using the 3-channel setting, the third channel may override such “blind spots” of the second channel.

### 11. EXPERIMENTAL RESULTS FOR ONE TEST EXAMPLE

In another experimental comparison, we constructed another dataset through our autonomous vehicles to evaluate the proposed model performance. The data was collected from different intersections in real-world driving environment in Arizona, USA, and these intersections have different types, including four-leg intersections, T-type intersections, signal controlled, non-signal controlled and so on. Other vehicles detected by our autonomous vehicles, and then corresponding history trajectories are extracted alone with real-time environment information, including map information, through a highly aggregated on-board pipeline.

The dataset contains 77,876 training samples, 25,962 validation samples, and 25,962 test samples, and d=100 m is adopted as searching distance when generating LRAs. The model is trained with 2 NVIDIA 2080-Ti GPU, and learning rate adopted in this work is 0.003, with loss threshold r=3. The result statistics are shown in TABLE I.

TABLE I
Model performance. The values show the ADE/FDE metrics in meters.

| Method | 4 S FDE | 4 S FDE std | 6 s FDE | 6 s FDE std | 6 s ADE |
|---|---|---|---|---|---|
| Resnet | 3.86 | 6.28 | 9.52 | 12.29 | 4.68 |
| Vanilla | 3.46 | 4.62 | 7.23 | 9.81 | 2.90 |
| LSTM | | | | | |
| SAPI w/out | 3.14 | 4.33 | 6.52 | 9.24 | 2.68 |
| LRAs | | | | | |
| SAPI w/out | 2.55 | 3.73 | 5.23 | 8.07 | 2.19 |
| traffic | | | | | |
| Proposed | 2.11 | 3.10 | 4.32 | 6.98 | 1.84 |

As can be seen from TABLE I, the proposed method outperforms all benchmarks in terms of ADE and FDE. For 6-second prediction, the proposed model has ADE/FDE of 1.84/4.32 meters. Considering the average vehicle length, which is around 4.2 m, the proposed model demonstrates acceptable performance. Furthermore, the result also indicates the promising performance of the proposed model from the perspective of model efficiency. Although the parameter size of Resnet34(v2) is about 4 times compared to that of the proposed model, the light-weighted SAPI still shows much better performance. It is ideal for real-world applications on autonomous vehicles, where computation time matters and computation resources are limited. It also demonstrates that the proposed model has higher prediction confidence, as it has lowest standard deviation for both midrange 4-second prediction and the total 6-second prediction among all benchmark methods.

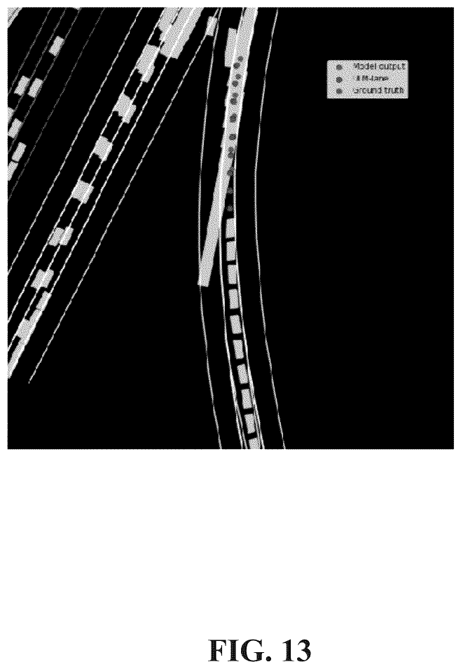

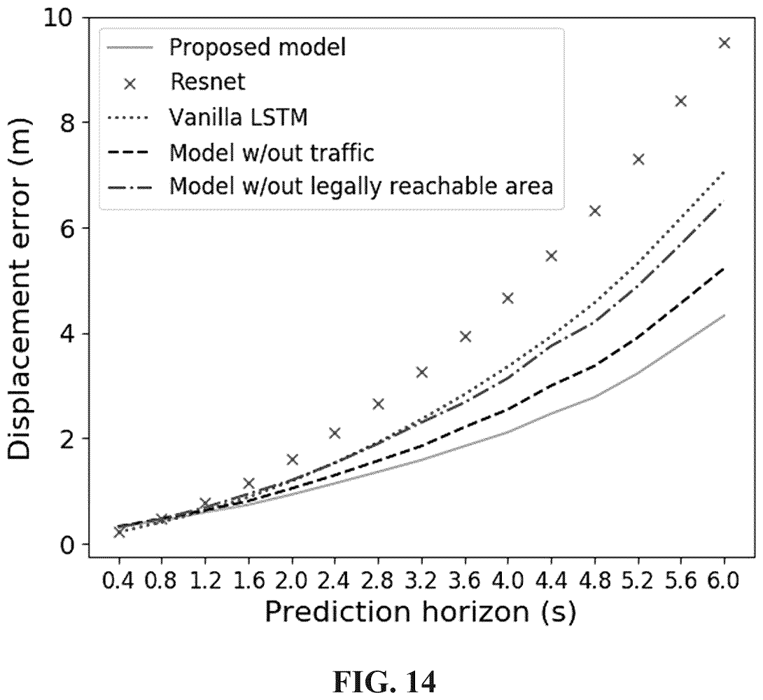

The detailed displacement error at each prediction time step is shown in FIG. 14. As demonstrated in FIG. 14, as prediction horizon increases, the displacement error increases correspondingly for all investigated methods. However, the proposed model shows the best performance compared to benchmark methods in 6-second prediction, with smallest final displacement error and slowest displacement error increasing trend. Resnet and vanilla LSTM shows low prediction error at the beginning, but its prediction error increases rapidly when prediction horizon increases, demonstrating their limitations on long-horizon prediction. As depicted in FIG. 14, model performance is impaired if LRAs or surrounding vehicle dynamics information is not available. The impact of LRAs to the model can be greater than that of surrounding traffic dynamics information, as the model shows worse performance if LRAs information is removed.

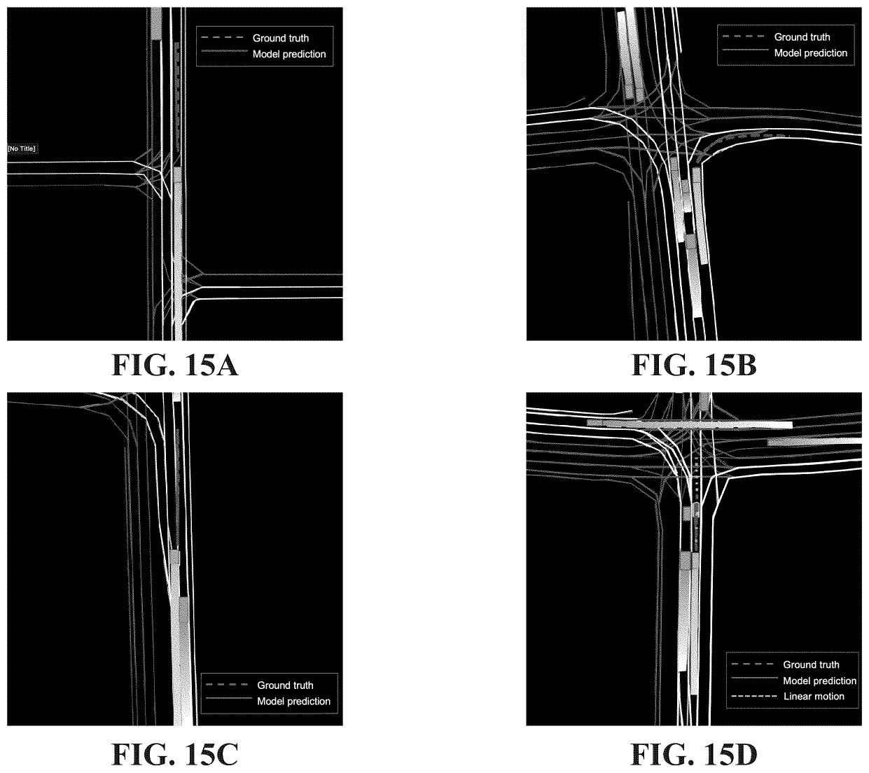

FIG. 15A-15D illustrate detailed model performance on representative scenarios, including going straight, turning, lane change, and stopping for traffic. For demonstration purpose, in FIG. 13A-13D, the center of each image is the latest position of target vehicle, which heads upward and is colored in yellow. In the figure, all latest positions of surrounding vehicles are shown in bounded blue boxes. History of vehicles in the scene are shown in faded intensity. In FIGS. 13A-13D, lane boundaries are colored in white if the lane is the same direction as the target vehicle, otherwise boundary lines are shown in gray. Virtual lanes (lanes without physical lane marks) are also included in the visualization.

As demonstrated in FIG. 15A-15D, the proposed SAPI model shows good performance in different scenarios. FIG. 15A shows that the model can accurately predict the trajectory of target vehicles which is moving straight in the future. In the turning case shown in FIG. 15B, the proposed model can accurately predict the right-turn motion of the target vehicle in advance. Though with a small final displacement error, the model still demonstrates high performance in the scenario. FIG. 15C showcases the SAPI model can successfully predict lane change behavior before it happens. As can be seen from FIG. 15D, the proposed model can also learn the impacts of surrounding traffic. For comparison, dashed line in FIG. 15D is the result of driving without slowing down (linear motion). Although traffic light status is not included when training, the proposed model can still predict that target vehicle will slow down in the future for crossing traffic. Because there are surrounding vehicles drive from right to left, proposing conflicts with the driving direction of the target vehicle. All scenarios shown in FIG. 15A-15D are safety concerns in real-world applications for autonomous vehicles. As aforementioned, the proposed model can accurately predict vehicle trajectories in such scenarios, which demonstrates its robustness and good prediction performance.

### 12. EXAMPLES OF VECTORIZED REPRESENTATION OF PREDICTION

In some embodiments, the environment around a vehicle may be represented using a vectorized representation. One example is vectornet that encodes HD maps and agent dynamics from vectorized representation. Another example is UAR representation. This may be used for merge window recommendation which predicts vehicle trajectory in a situation where either the vehicle merges into traffic or another vehicle may merge into the traffic in front of the target vehicle.

### 13. EXAMPLES OF RASTERIZED REPRESENTATION OF PREDICTION

In some embodiments, the environment around a vehicle may be represented using a rasterized representation. One aspect includes multimodal trajectory prediction for autonomous driving using deep convolutional networks. Another example includes a multipath probabilistic anchor trajectory hypothesis for behavior prediction. Another example includes heatmap output for future motion estimation. Another example is the model described in the present document.

### 14. EXAMPLE PIPELINE

In some embodiments, prediction feature extraction may be achieved by a pipeline of processing of images. To prepare and to extract training data for the local prediction pipeline, a feature extraction includes five main parts:
Feature extractor
Label extractor
On-board predicted trajectory extractor
Prediction utils
Data saver

### 15. EXAMPLES OF FEATURE EXTRACTOR

The pipeline extracts features every pre-determined time period such as every 0.4 seconds, for a total period of 4.8 s (12 timestamps). At each timestamp, the pipeline first checks if an NPC is valid or not. The definition of a valid NPC may be:
The NPC is on map
Has enough observation (threshold=10 observations)
It's bounding lane is in the intersection region, or
Searching a predetermined distance (e.g., 100 m) forward/backward, it's forward lanes/backward lanes are in the intersection region

The second step of the feature extractor is to determine and extract if the NPC is in a signal-controlled intersection. The information will be stored in binary (0: non-signal-controlled, 1: signal-controlled). Ego position, NPC object type, timestamps are also retrieved and aggregated in the feature. Additional information include:
1. history trajectory: in this pipeline, two types of trajectories are retrieved through two different application programmers interfacesAPIs: i) using TrajectoryPointAt API, stored as trajectory_points; ii) using PositionAt API, stored as trajectory_points_tsmap3. The latter is used for training.
2. Environment representation images: The pipeline uses a single channel image to represent the environment at each history timestamp, including legally reachable areas and surrounding vehicle dynamics. Legally reachable area is defined as the region the NPC can be accessed at that time step, including:
[a] the current lane, nearby lanes (left/right lanes) if lane boundaries are marked as “ALLOWPASS”.
[b] Forward lanes (100 m region) of the current lane and forward lanes of nearby legally reachable lanes (100 m).

Section 8 provides additional details of LRA processing.

### 16. EXAMPLES OF LABEL EXTRACTOR

The label extractor performs the task of extracting the ground truth future trajectory given a timestamp. At the current timestamp, the labeler finds the future 6-second positions of the NPC and retrieves it. If the ground truth is not valid, then the NPC is skipped. The time gap between two adjacent positions is 0.4 s in the pipeline. When needed, the ground truth position is interpolated through an interpolation function.

### 17. EXAMPLES OF ON-BOARD PREDICTED TRAJECTORY EXTRACTOR

To validate and benchmark the model performance, on-board predicted trajectories are extracted. First of all, a predictor topic is added. Given a timestamp, the predicted trajectory of an npc is retrieved in the labeler. A new variable called pred_info is declared in the labeler. When retrieving ground truth, the predicted trajectory is retrieved at the same time. At each time step, the pred_info stores: position x, position y and velocity. Given an npc object_id, the pipeline aggregates the ground truth trajectory and predicted trajectory together.

### 18. EXAMPLES OF TECHNICAL SOLUTIONS

Below is a listing of various technical solutions adopted by some preferred embodiments.
1. A method of predicting vehicle trajectory, comprising: receiving information indicative of a surrounding environment of a vehicle; receiving a history of vehicle trajectories; determining learned patterns by separately operating a first encoder on the surrounding information and a second encoder on the history of vehicles trajectories; and determining one or more predicted future trajectories for the vehicle based on the learned patterns. FIG. 2 depicts an example of this method.
2. The method of solution 1, wherein the information indicative of the surrounding environment is represented as a combination of a vectorized representation and a rasterized representation. Further details are disclosed at least in sections 5, 8, 13 and 14 of the present document.
3. The method of any of solutions 1-2, wherein the information indicative of the surrounding environment includes a first channel indicating a surrounding environment and a surrounding vehicle dynamics and a second channel indicating legally reachable areas for the vehicle. Further details are disclosed at least in sections 5 and 8 of the present document.
4. The method of any of solutions 1-3, wherein the first encoder comprises a convolutional neural network. Further details are disclosed at least in sections 6 to 15 of the present document.
5. The method of any of solutions 1-4, wherein the first encoder comprises a three-dimensional 3D convolutional layer, followed by a 3D average pooling stage, followed by a squeeze and a two-dimensional 2D convolutional layer. Further details are disclosed at least in sections 6 to 15 of the present document.
6. The method of any of solutions 1-5, wherein the second encoder comprises a cascade of a long short-term memory encoder, a 1D convolutional layer, a maxpooling stage and a 1D convolutional layer. Further details are disclosed at least in sections 6 to 15 of the present document.
7. The method of any of solutions 1-6, wherein learned patterns are determined by refining a weighted combination of the output of the second encoder and the history of vehicle trajectories. Further details are disclosed at least in sections 6 to 15 of the present document.
8. The method of any of solutions 1-7, wherein the one or more predicated future trajectories are determined by operating a decoder comprising a recurrent neural network and a stage for conversion to a dense layer that operates on an output of the refining. Further details are disclosed at least in sections 6 to 15 of the present document.
9. The method of any of solutions 1-8, wherein the surrounding environment comprises a street intersection. Further details are disclosed at least in sections 4 to 15 of the present document
10. The method of any of solutions 1-9, wherein the one or more future trajectories includes a trajectory of the vehicle near an intersection, along a curvy road, while turning or while making a lane change. Further details are disclosed at least in sections 6 to 15 of the present document.
11. A method of predicting vehicle trajectory, comprising: operating a scene encoder on an environmental representation surrounding a vehicle; concatenating an output of the scene encoder with a history trajectory; applying a sequence encoder to a result of the concatenating; refining an output of the sequence encoder based on the history trajectory; and generating one or more predicted future trajectories by operating a decoder on an output of the refining. An example flowchart is depicted in FIG. 3.
12. The method of solution 11, wherein the environmental representation surrounding the vehicle is represented as a combination of a vectorized representation and a rasterized representation. Further details are disclosed at least in sections 4 to 15 of the present document
13. The method of any of solutions 11-12, wherein the environmental representation isa two channel image in which a first channel indicating a surrounding environment and a surrounding vehicle dynamics and a second channel indicating legally reachable areas for the vehicle. Further details are disclosed at least in sections 6 to 15 of the present document.
14. The method of any of solutions 11-13, wherein the scene encoder comprises a convolutional neural network. Further details are disclosed at least in sections 6 to 15 of the present document.
15. The method of solutions 11-14, wherein the scene encoder comprises a 3D convolutional layer, followed by a 3D average pooling stage, followed by a squeeze and a 2D convolutional layer. Further details are disclosed at least in sections 6 to 15 of the present document.
16. The method of any of solutions 11-15, wherein the sequence encoder comprises a cascade of a long short-term memory encoder, a ID convolutional layer, a maxpooling stage and a ID convolutional layer. Further details are disclosed at least in sections 6 to 15 of the present document.
17. The method of any of solutions 11-16, wherein the refining uses a weighted combination of the output of the sequence encoder and the history trajectory. Further details are disclosed at least in sections 6 to 15 of the present document.
18. The method of any of solutions 11-17, wherein the decoder comprises a recurrent neural network and a stage for conversion to a dense layer that is used for generating one or more predicted future trajectories. Further details are disclosed at least in sections 6 to 15 of the present document.
19. The method of any of solutions 11-18, wherein the surrounding environment comprises a street intersection. Further details are disclosed at least in sections 6 to 15 of the present document.
20. The method of any of solutions 11-19, wherein the one or more future trajectories includes a trajectory of the vehicle near an intersection, along a curvy road, while turning or while making a lane change. Further details are disclosed at least in sections 6 to 15 of the present document.
21. An apparatus comprising one or more processors configured to implement a method recited in any of solutions 1-20. The apparatus may be implemented on a hardware platform that includes some of the modules described in Section 3 of the present document.
22. A computer-readable medium having code stored thereon, the code carrying processor-executable instructions for implementing any of solutions 1-20.

In the solutions disclosed above, the pixel value images as described with reference to FIGS. 2A-2C, FIGS. 7A-11D and FIGS. 13A-13D may be used.

I In the solutions disclosed above, a combination of vectorized and rasterized representations that takes into account BEV may be used.

In the solutions disclosed above, in some embodiments, a three-channel input may be used, wherein the third channel may provide a smoothening effect as described in the present document.

In the solutions disclosed above, two successive stages of encoder are described, but it will be appreciated by one of skill in the art that additional encoders may be used to further refine results of previous encoding stage.

In the solutions disclosed above, the average pooling stage may comprise averaging values across each patch of the feature map and replacing the patch with the averaged value, thus resulting in a reduction in the amount of data that needs to be processed by the subsequent stage.

In the solutions disclosed above, the squeeze operation may include reducing data by eliminating dimensions where there is no unextracted information.

In the solutions disclosed above, the maxpooling stage may include calculating a maximum value for different patches of a feature map generated by the model. This maximum value is used to create a downsampled version of the feature map, thus resulting in data reduction while maintaining important features identified in the processed image information.

In the solutions disclosed above, the learning of the weighted combination may include

The vehicle trajectory determined according to the solution above may be further used to make a navigation decision about the target vehicle by factoring into the decision process each predicted trajectory and a probability associated with the predicted trajectory. The outcome of such a navigation may be fed back for the history of vehicle trajectories used for subsequent prediction models.

### 19. FINAL REMARKS

In this document we propose a learning-based vehicle trajectory prediction model, i.e., SAPI. It uses an abstract way to represent and encode surrounding environment, by utilizing information from real-time map, right-of-way, and surrounding traffic. Due to the abstract representation setting, the environment representation strategy is flexible, and can be extend to future applications to incorporate more critic surrounding environment information, such as traffic light status and real-time changes of traffic management. SAPI contains two encoders and one decoder. A refiner is also proposed in the work to conduct a look-back operation, in order to make full use of history trajectory information. We evaluate SAPI based on a proprietary dataset collected in real-world intersections through autonomous vehicles. It is demonstrated that SAPI shows promising performance when predicting vehicle trajectories at intersections and outperforms benchmark methods in 6-second vehicle trajectory prediction, with ADE/FDE being 1.84/4.32 m respectively. We also show that the proposed model demonstrates good performance when predicting vehicle trajectories in different scenarios, which ensures the safety of real-world applications on autonomous vehicles.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of predicting vehicle trajectory, comprising:
receiving information indicative of a surrounding environment of a vehicle;
receiving a history of vehicle trajectories;
determining learned patterns by separately operating a first encoder on the surrounding information and a second encoder on the history of vehicles trajectories; and
determining one or more predicted future trajectories for the vehicle based on the learned patterns.

2. The method of claim 1, wherein the information indicative of the surrounding environment is represented as a combination of a vectorized representation and a rasterized representation.

3. The method of claim 1, wherein the information indicative of the surrounding environment includes a first channel indicating a surrounding environment and a surrounding vehicle dynamics and a second channel indicating legally reachable areas for the vehicle.

4. The method of claim 1, wherein the first encoder comprises a convolutional neural network.

5. The method of claim 1, wherein the first encoder comprises a three-dimensional 3D convolutional layer, followed by a 3D average pooling stage, followed by a squeeze and a two-dimensional 2D convolutional layer.

6. The method of claim 1, wherein the second encoder comprises a cascade of a long short-term memory encoder, a 1D convolutional layer, a maxpooling stage and a 1D convolutional layer.

7. The method of claim 1, wherein learned patterns are determined by refining a weighted combination of an output of the second encoder and the history of vehicle trajectories.

8. The method of claim 1, wherein the one or more predicted future trajectories are determined by operating a decoder comprising a recurrent neural network and a stage for conversion to a dense layer that operates on an output of a refining stage.

9. The method of claim 1, wherein the surrounding environment comprises a street intersection.

10. The method of claim 1, wherein the one or more future trajectories includes a trajectory of the vehicle near an intersection, along a curvy road, while turning or while making a lane change.

11. A method of predicting vehicle trajectory, comprising:
operating a scene encoder on an environmental representation surrounding a vehicle;
concatenating an output of the scene encoder with a history trajectory;
applying a sequence encoder to a result of the concatenating;
refining an output of the sequence encoder based on the history trajectory; and
generating one or more predicted future trajectories by operating a decoder on an output of the refining.

12. The method of claim 11, wherein the environmental representation surrounding the vehicle is represented as a combination of a vectorized representation and a rasterized representation.

13. The method of claim 11, wherein the environmental representation is a two channel image in which a first channel indicating a surrounding environment and a surrounding vehicle dynamics and a second channel indicating legally reachable areas for the vehicle.

14. The method of claim 11, wherein the scene encoder comprises a convolutional neural network.

15. The method of claim 11, wherein the scene encoder comprises a 3D convolutional layer, followed by a 3D average pooling stage, followed by a squeeze and a 2D convolutional layer.

16. The method of claim 11, wherein the sequence encoder comprises a cascade of a long short-term memory encoder, a 1D convolutional layer, a maxpooling stage and a 1D convolutional layer.

17. The method of claim 11, wherein the refining uses a weighted combination of the output of the sequence encoder and the history trajectory.

18. The method of claim 11, wherein the decoder comprises a recurrent neural network and a stage for conversion to a dense layer that is used for generating one or more predicted future trajectories.

19. The method of claim 11, wherein the one or more future trajectories includes a trajectory of the vehicle near an intersection, along a curvy road, while turning or while making a lane change.

20. An apparatus comprising one or more processors configured to implement a method, comprising;
receiving information indicative of a surrounding environment of a vehicle;
receiving a history of vehicle trajectories;
determining learned patterns by separately operating a first encoder on the surrounding information and a second encoder on the history of vehicles trajectories; and
determining one or more predicted future trajectories for the vehicle based on the learned patterns.
